(19) United States
(12) Patent Application Publication
(10) Pub. No.: US 2007/0136812 A1
(43) Pub. Date: Jun. 14, 2007

(54) Computer Virus Preventive System

(75) Inventor: Wei Qiu, Los Angeles, CA (US)

Correspondence Address: Wei Qiu, #201, 1914 Selby Ave., Los Angeles, CA, 90025, US

(73) Assignee: Dr. Hong Yu, Los Angeles, CA (US)

(21) Appl. No.: 11/554,002

(22) Filed: Oct. 28, 2006

(30) Foreign Application Priority Data
Dec. 12, 2005 (JP) 305054533

(51) Int. Cl. G06F 12/14

(52) U.S. Cl. 726/24

(57) ABSTRACT

A virus preventive system detects computer viruses by file pattern verification mechanism. It registers an original file pattern which is permitted to be accessed into the Verification Data Base. Registration of a file occurs before it is executed, which allows confirming if the file has been falsified. The Verification Data Base will be verified automatically by the Verification Client, which is served by the Verification Server. Consequently the present invention vouches for the validity of files so that it prevents the invasion of new computer viruses even though there is no knowledge about the viruses or malicious programs. Therefore, the present invention is able to prevent damage from all malicious computer programs beforehand.

### FIELD OF THE INVENTION

The present invention is a computer virus preventive system that protects computers from computer viruses or malicious programs.

### BACKGROUND OF THE INVENTION

Conventional anti-virus mechanism detects viruses by using a virus pattern database. The mechanism checks target files with the virus pattern database to detect and terminate viruses. By using this mechanism, only viruses that have been registered in the virus pattern database can be detected. Therefore, new unregistered viruses are free to spread into the computer system to cause problems until new virus patterns are added into the database and the database has been updated.

Conventional anti-virus mechanism is a treatment system; the damage caused by new unknown viruses cannot be prevented. And the treatment is limited sometimes due to the wide range of viruses that may require complex treatments, which cannot be simply performed by the anti-virus programs.

### SUMMARY OF THE INVENTION

The present invention is a computer virus preventive system that detects viruses by file pattern verification mechanism. Instead of using a virus pattern database, it registers original file pattern which is permitted to be accessed into the Verification Database. When an application accesses a file, the file will be verified automatically by calling the Verification Client Interface. The Verification Client will connect the Verification Server that searches the Verification Database to find the registered data of the file. Then the Verification Server confirms if the file has been falsified. Consequently the present invention vouches validity of files so that it inhibits from invasion of computer viruses or malicious programs to safeguard computer system even though there is no knowledge about the viruses or malicious programs. Using the present invention, the viruses that are not registered can be detected by file pattern verification mechanism. Therefore, the present invention is able to prevent damage from all malicious computer programs beforehand.

### DETAILED DESCRIPTION OF THE INVENTION

The present computer virus prevention system is supported by a client/server system and the File Pattern Code (called FP Code) verification mechanism. The system structure is shown in FIG. 1 and the verification processes are shown in FIGS. 8-11.

Referring to FIGS. 8-11, applications that access local or network files call the Verification Client Interface. First, the Verification Client accesses the Verification Environment Data (shown in FIG. 4) to decide a verification process. Then the Verification Client connects the Verification Server to send the Verification Request Data (shown in FIG. 2). The Verification Server searches the Verification Data Base (shown in FIG. 5) by the File Name, File Size and Verification Level. If a file is registered, the Verification Server will compare the request data and the registered data to confirm if the file is falsified.

The Verification Server returns the Response Data (shown in FIG. 3) to the Verification Client. Then the Verification Client analyzes the Response Data and informs application if the file is accessed. Therefore, it inhibits from invasion of computer viruses or malicious programs. The present computer virus prevention system is a network server/client system so that it also works through the internet.

The Verification Server verifies requested data (shown in FIGS. 2 and 6) to confirm if the file is falsified. The requested data includes the File Pattern Code (called FP Code), Verification Level, File Size and File Name.

The Verification Environment Data is used to decide the process of verification. The Verification Environment Data is maintained by the Verification Environment Setting.

The Verification Environment Setting maintains the Verification Environment Data in order to maintain verification process and security.

The Verification Data Base gives essential information to the Verification Server. The Verification Data Base can be searched, added, modified and deleted by the Verification Data Base Maintenance system.

The Verification Data Base Maintenance generates the FP Code and maintains the functions of the Verification Database such as data searches, additions, modifications and deletions. The FP Code supports the automatic verification mechanism.

When a file is accessed, the verification mechanism makes a FP Code for the file. Then, the verification mechanism searches the Verification Data Base and compares the FP Code between the original file that has already been registered and a file that will be accessed to confirm if they are the same. It is meaningless to break this verification mechanism or the FP Code because the FP Code is depended on the file self like finger printing verification system. This verification mechanism innovates the Verification Level to solve contradiction between file size and access speed. Even for a 10 Mbytes huge file, the area that can be falsified is only 10 Mb/128 (FP Code length)/127 (Verification Level)=615 bytes. It is very difficult to put virus into. The speed to generate a FP Code is very fast because of the simple algorithm. This system takes about 10 minutes to generate 100,000 FP codes as shown in FIG. 7.

### BRIEF DESCRIPTION OF THE DRAWINGS

FIG. 1 illustrates system structure of the computer virus prevention system.

FIG. 2 illustrates Verification Request Data from the Verification Client.

FIG. 3 illustrates Response Data from the Verification Server.

FIG. 4 illustrates Verification Environment Data.

FIG. 5 illustrates data structure of the Verification Data Base.

FIG. 6 illustrates mechanism of the FP Code generation.

The FP Code mechanism:
a. Divides file into 128 blocks.
b. Calculates offset of every block with rules shown below.
c. Samples 1 Bit at offset of block from each block.

Sample Rules:
a. n=1 to 127 (verification level)
b. s=integer(log 2n) (layer depending on n)
c. t=n−2s (order in layer s)
d. offset=(t+1)/2(s+1) (when t is even number)
e. offset=1−t/2(s+1) (when t is odd number)

FIG. 7 illustrates verification data sample.

FIG. 8 is a flowchart of the verification process.

FIG. 9 continues the flowchart of the verification process.

FIG. 10 continues the flowchart of the verification process.

FIG. 11 continues the flowchart of the verification process.

What is claimed is:

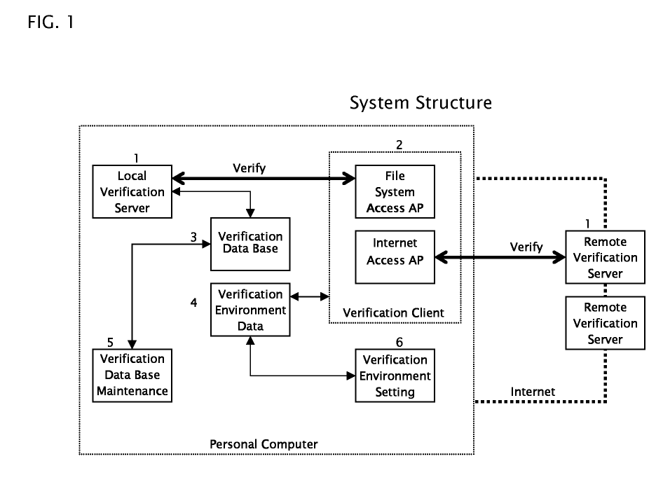

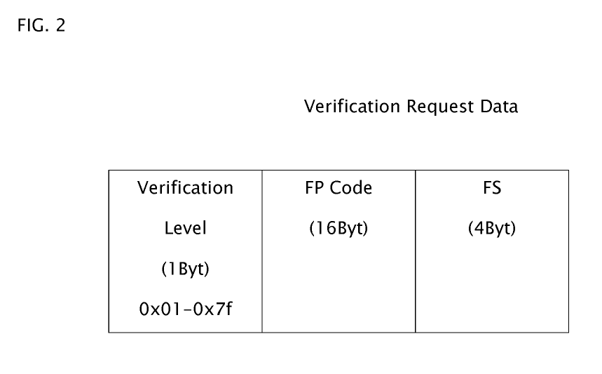

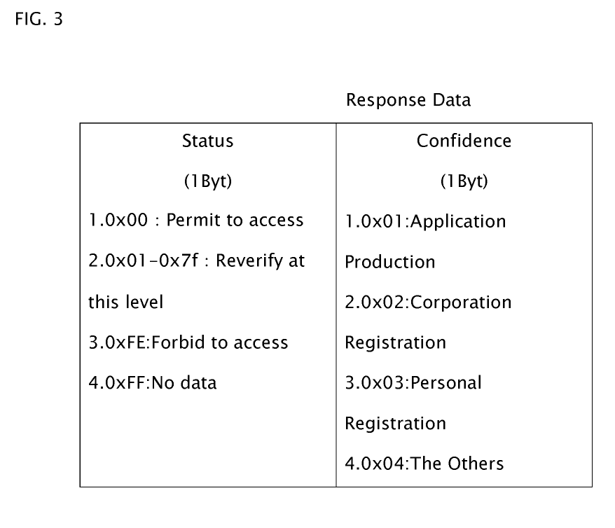

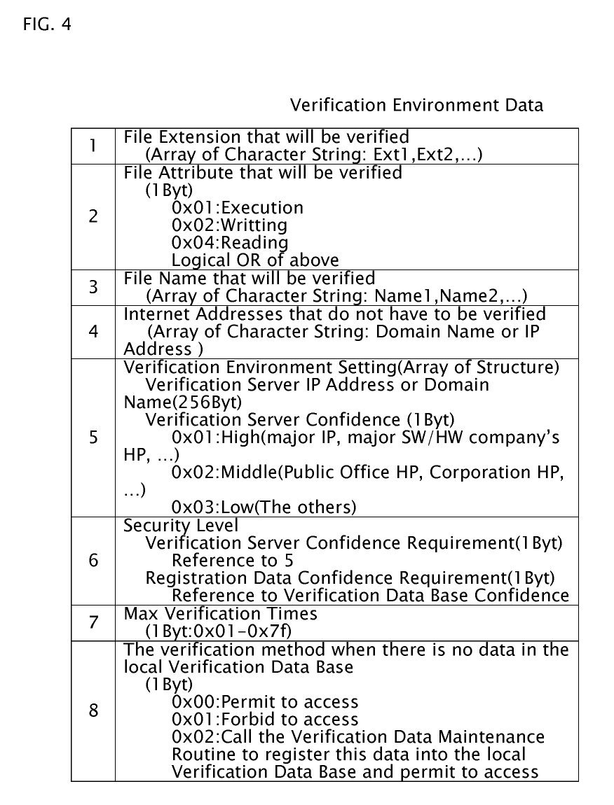

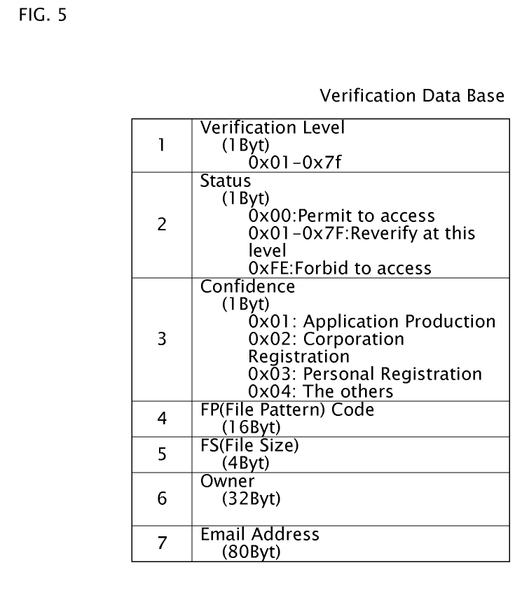

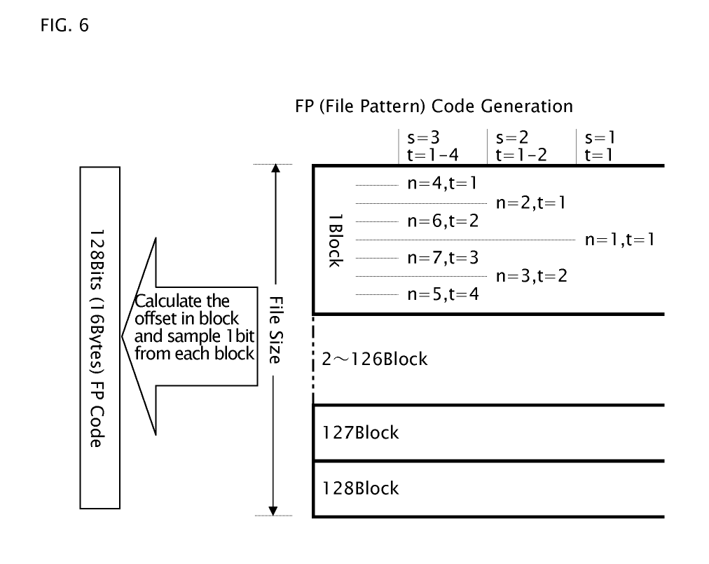

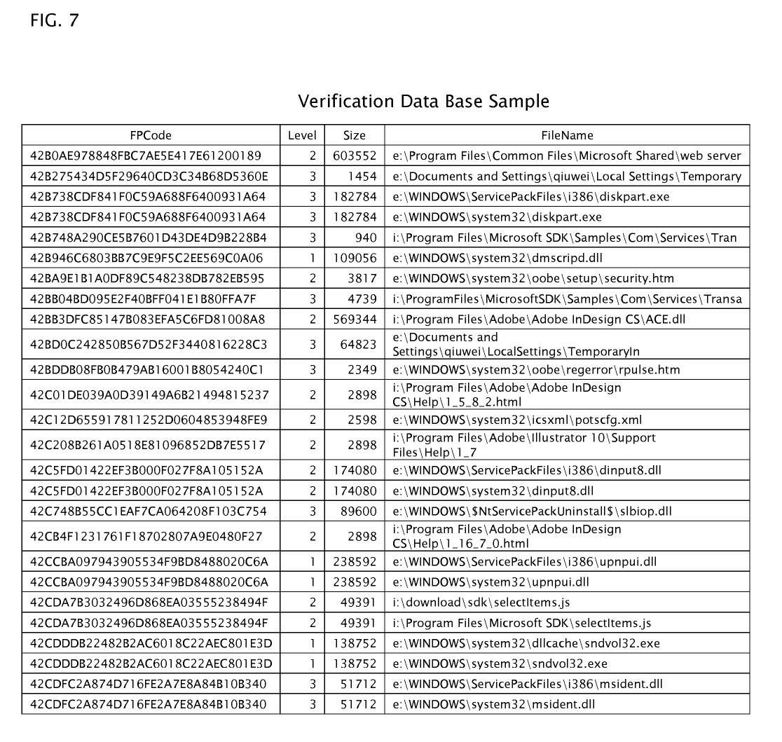

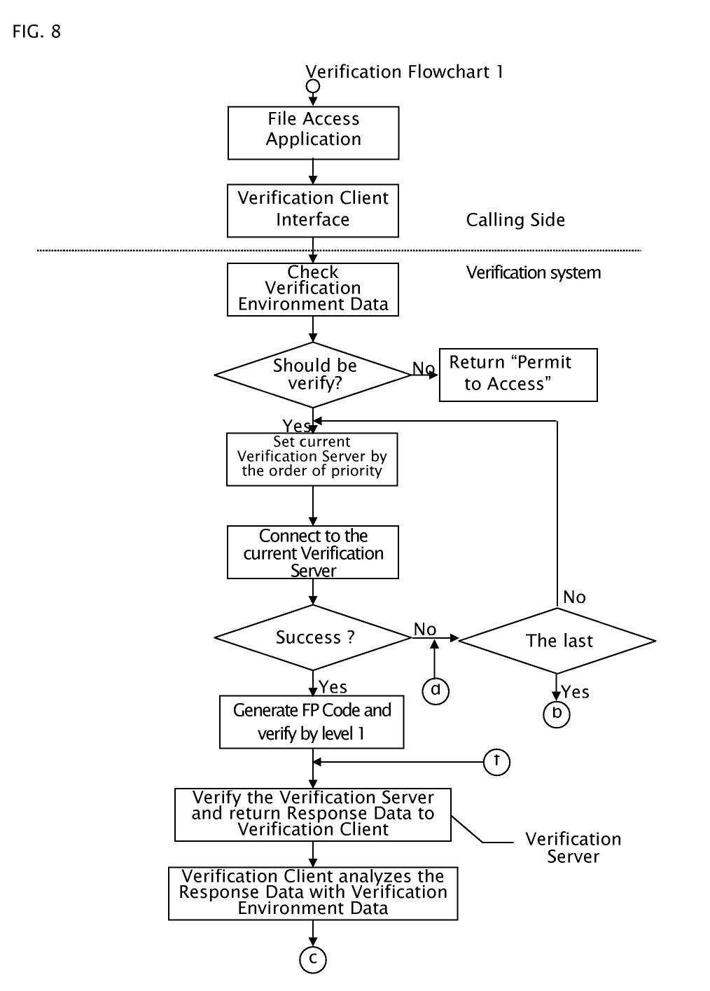

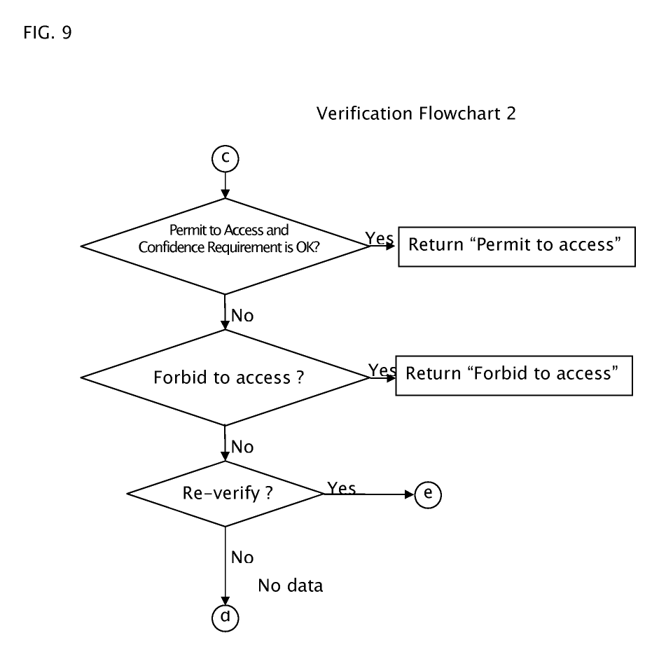

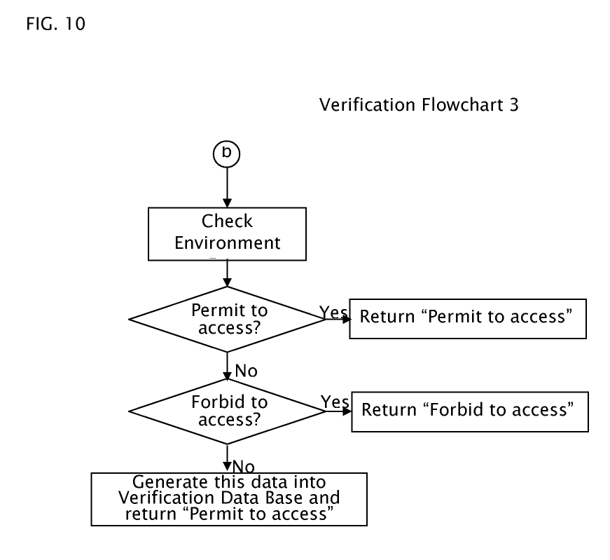

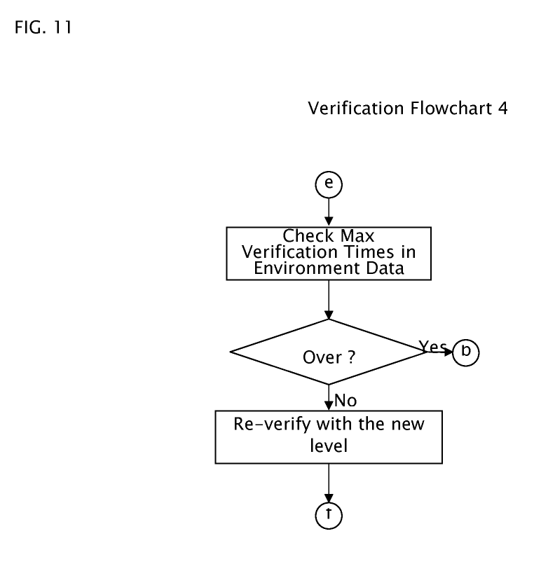

1. The present invention is a computer virus preventive system that protects computers from viruses or malicious programs. The system as illustrated in FIG. 1-11, includes following modules: 1) Verification Server. 2) Verification Client. 3) Verification Database. 4) Verification Environment Data. 5) Verification Data Maintenance. 6) Verification Environment Setting.

2. The system as claimed in claim 1, wherein the Verification Server receives a Verification Request Data from the Verification Client. The Verification Request Data includes 1) File Pattern Code (called FP Code). 2) Verification Level. 3) File Size. 4) File Name. The Verification Server searches the Verification Data Base by File Name, File Size and Verification Level to check if the file has been registered. Then the Verification Server compares the FP Code between the Verification Request Data and the Verification Data Base to confirm if the file is falsified. After verifying the data, the Verification Server returns the Response Data to the Verification Client. The Verification Server also works through the internet.

3. The system as claimed in claim 1, wherein the Verification Client is an interface that is used by applications. The Verification Client includes four functions, which are: 1) Deciding process of verification with the Verification Environment Data. 2) Generating the FP Code of a file. 3) Requesting the Verification Server. 4) Analyzing the Response Data and returning results to applications.

4. The system as claimed in claim 1, wherein the Verification Data Base gives essential information to the Verification Server. The Verification Data Base can be searched, added, modified and deleted by the Verification Data Maintenance.

5. The system as claimed in claim 1, wherein the Verification Environment Data gives information to the Verification Client to decide verification process and security level. The Verification Environment Data is maintained by the Verification Environment Setting module.

6. The system as claimed in claim 1, wherein the Verification Data Base Maintenance generates the FP Code of a registered file and it maintains the Verification Data Base such as data searches, additions, modifications and deletions.

7. The system as claimed in claim 1, wherein the File Pattern Code (called FP Code) supports the verification mechanism.

8. The system as claimed in claim 1, wherein the Verification Environment Setting maintains the Verification Environment Data in order to decide verification process and security level.
